(19) United States
(12) Patent Application Publication
(10) Pub. No.: US 2026/0361749 A1
(43) Pub. Date: Nov. 12, 2026

(54) IN-SITU RESOURCE PROFILER ENGINES FOR DETECTING SECURITY EXPOSURES WITHIN A NETWORKED ENVIRONMENT

(71) Applicant: Microsoft Technology Licensing, LLC, Redmond, WA (US)

(72) Inventor: Fady COPTY, San Jose, CA (US)

(21) Appl. No.: 19/202,216

(22) Filed: May 8, 2025

(51) Int. Cl. H04L 9/40

(52) U.S. Cl. CPC H04L 63/1433; H04L 63/205

(57) ABSTRACT

Systems and methods herein provide an in-situ resource profiler (IRP) engine and its related functions. In an aspect, an IRP engine may identify a plurality of hierarchy levels within a networked environment, wherein the plurality of hierarchy levels defines an organizational architecture of a plurality of resources. The IRP engine may determine hierarchy-level context of each hierarchy level and generate a plurality of resource profiles for the plurality of resources based on the hierarchy-level context. The resource profiles may include a resource role and design pattern of a respective resource within the networked environment. Based on the plurality of resource profiles, the IRP engine may detect one or more potential security exposures within the networked environment.

### TECHNICAL FIELD

Aspects of the disclosure are related to the field of computer software applications and services and, in particular, to in-situ resource profiler (IRP) engines for detecting security exposures within a networked environment.

### BACKGROUND

Networked environments are becoming increasingly common in the digital era, serving as foundational infrastructures that connect a wide range of resources, including servers, databases, applications, virtual machines, containers, and user devices. These networked environments are typically organized into hierarchical structures, where resources are grouped and managed across multiple levels of abstraction to support scalability, flexibility, and efficient administration. This hierarchical organization allows enterprises to structure their digital infrastructure across elements such as subscriptions, resource groups, networks, subnets, and individual resources, enabling streamlined deployment, management, and operation of complex, interconnected systems.

### SUMMARY

Technology disclosed herein includes software applications and services that provide an in-situ resource profiler (IRP) engine, and its related functions. In an aspect, the IRP engine may analyze a networked environment containing multiple resources to determine a security posture of the networked environment. To determine the security posture, the IRP engine may initially determine multiple hierarchy levels that define the networked environment’s organizational architecture. For the hierarchy levels, the IRP engine may then determine hierarchy-level context for each level, such as by accessing a contextual security representation of the networked environment and extracting hierarchy-specific information.

Using the hierarchy-level context, the IRP engine may generate resource profiles for the resources within the networked environment. The resource profiles may identify a respective resource's role and design pattern within the networked environment. In some embodiments, the IRP engine may validate a resource profile as determined at a first hierarchy level against the resource profile determined at another hierarchy level to ensure consistency of a resource's role and/or design pattern across the hierarchy levels. Based on the resource profiles, the IRP engine may generate hierarchy-level summaries for the hierarchy levels. The hierarchy-level summaries may provide additional contextual information about a respective hierarchy level, such as the total number of resources, distribution of resource types, common design patterns observed, relationships between resources within the same level, contextual connections between resources in adjacent levels, statistics on access controls, network configurations, and compliance status relevant to each hierarchy level. Then using the hierarchy-level summaries, the IRP engine may validate them to determine whether any discrepancies or potential security exposures are present within the networked environment. Responsive to detecting a discrepancy and/or potential security exposure, the IRP engine may generate a recommendation including a mitigation action for remedying or addressing any identified issue.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing an in-situ resource profiler (IRP) engine, according to an embodiment herein;

FIG. 2 illustrates an example networked environment including multiple hierarchy levels, according to various embodiments herein;

FIG. 3 illustrates an example environment in which an IRP engine is leveraged for determining a security posture of a networked environment, according to various embodiments herein;

FIG. 4 illustrates a process for providing an IRP engine and one or more of its functions, according to various embodiments herein; and

FIG. 5 shows an example client device suitable for providing an IRP engine and related functions, according to an embodiment herein.

### DETAILED DESCRIPTION

A networked environment is a structured system of interconnected computing resources, designed to facilitate communication, data exchange, and resource sharing across various devices, applications, and services. In the modern world, organizations leverage networked environments to support a wide range of digital operations, from cloud computing and data storage to enterprise applications and remote collaboration. Networked environments enable businesses to deploy scalable infrastructure, integrate distributed systems, and manage resources efficiently across on-premises data centers, cloud platforms, and hybrid architectures. By connecting servers, databases, user devices, and applications within a cohesive framework, networked environments form the backbone of modern digital ecosystems, driving operational agility, enabling real-time data access, and supporting the growing demands of global connectivity and digital transformation initiatives.

Networked environments are often organized into multiple hierarchical levels, where resources are arranged according to varying degrees of abstraction and logical grouping. This hierarchical structure allows organizations to efficiently manage complex infrastructures by segmenting resources into hierarchy levels such as accounts or subscriptions, resource groups, virtual networks, subnets, and individual compute or storage resources. Each level within the hierarchy defines a specific scope for administration, access control, policy enforcement, and network segmentation, enabling structured deployment and streamlined oversight of large-scale, distributed systems. This hierarchical architecture is fundamental to modern cloud architectures, enterprise data centers, and hybrid environments, providing a scalable framework for resource management.

Within these hierarchical architectures, resources may serve different purposes or exhibit varying configurations depending on their position within the hierarchy levels. For example, a virtual machine deployed within a public-facing subnet may function as a web server, while an identical virtual machine type placed within a backend subnet may serve as a database host or application server. Similarly, access controls, network exposure, and security policies applied to a resource can differ, at times significantly, based on the administrative boundaries or network segments in which the resource resides within the hierarchy levels. This contextual variability means that identical resource types can fulfill distinct operational roles, depending on how and where they are deployed within the networked environment.

The dynamic roles and diverse design patterns of resources across hierarchy levels present numerous challenges, particularly in the context of detecting security exposures. A resource that appears properly configured in isolation may introduce vulnerabilities when its role, relationships, or placement within the hierarchy levels are considered. Inconsistencies in configurations, misaligned access controls, or deviations from established design patterns can create hidden security gaps that are difficult to identify using traditional monitoring approaches. These challenges are further amplified by the fluid nature of modern networked environments, where resources are frequently provisioned, modified, or decommissioned to meet evolving operational demands. As a result, accurately assessing security posture requires a comprehensive understanding of how resource roles and configurations align with expected design patterns across the multiple hierarchy levels within the networked environment.

Failure to properly identify and address security exposures within a networked environment can lead to numerous negative consequences for organizations. Undetected misconfigurations, excessive access permissions, or overlooked vulnerabilities can create entry points for malicious actors, increasing the risk of data breaches, unauthorized access, and lateral movement within the infrastructure. These security gaps may compromise sensitive information, disrupt services, and result in financial losses, regulatory penalties, and reputational damage. Additionally, without a clear understanding of resource roles and their associated risks, organizations may struggle to prioritize remediation efforts, leaving high-risk exposures unaddressed while expending resources on lower-priority issues. In dynamic networked environments where changes occur rapidly, the inability to detect and respond to security exposures in a timely manner further exacerbates these risks, potentially allowing threats to persist undetected for extended periods.

To address at least these shortcomings of conventional security frameworks, example in-situ resource profiler (IRP) engine(s) are provided herein. In particular, the IRP engine provided herein may identify and analyze resources across multiple hierarchy levels within a networked environment, determining hierarchy-level context and generating resource profiles that capture the roles and design patterns of each resource. By leveraging this contextual understanding, the IRP engine can detect potential security exposures, misconfigurations, and deviations from expected design patterns that may not be apparent when resources are evaluated in isolation. The “in-situ” nature of the IRP engine allows it to analyze resources in their native operational context, observing their behavior, interactions, and configurations as they exist and function within the live networked environment. This real-time, contextual analysis enables the IRP engine to fully appreciate and understand the dynamic nature of resources, capturing their evolving roles and relationships in a continuously changing environment.

As will be expanded on in greater detail below, the IRP engine may validate the resource profiles across different hierarchy levels and generate comprehensive summaries, thereby enabling organizations to gain deeper insights into their networked environment’s security posture. This approach allows for more effective identification of vulnerabilities, prioritization of remediation efforts, and adaptation to the dynamic nature of modern networked environments, ultimately enhancing an organization’s ability to protect against and respond to potential security threats. Furthermore, the IRP engine may generate targeted recommendations for addressing identified security exposures, misalignments, or discrepancies in design patterns and resource roles across hierarchy levels. These recommendations may include specific mitigation actions to rectify misconfigurations, adjust access controls, or realign resources with expected design patterns, providing organizations with actionable insights to improve their overall security posture and operational efficiency.

By identifying potential security exposures present within a networked environment, the IRP engine provides numerous benefits over conventional approaches to network security. The IRP engine not only enhances an organization’s ability to proactively manage risk within complex networked environments, but the IRP engine can uncover hidden vulnerabilities arising from misconfigurations, inconsistent access controls, or improper resource placements that traditional security tools might overlook due to limited contextual awareness. The IRP engine may detect subtle or emergent security exposures before they are exploited by analyzing resource roles, design patterns, and their relationships across hierarchical levels. This analysis enables security teams to address risks more effectively, reduce the attack surface, and improve overall resilience of the networked environment against cyber threats. Furthermore, the ability to identify previously undetectable security exposures supports compliance efforts, streamlines incident response, and provides greater confidence in the security posture of dynamic and distributed infrastructures.

As will be highlighted in the following discussion, the IRP engine provided herein represents a technological advancement in the field of network security by tackling the specific technical challenge of accurately assessing and maintaining security in complex, hierarchical networked environments. Unlike conventional approaches that simply collect and aggregate data about resources within a networked environment, the IRP engine leverages advanced technical methods, such as in-situ resource profiling and cross-hierarchy validation, to deliver tangible improvements to the functioning of networked systems. By dynamically analyzing resources in their live operational context and correlating information across multiple layers of abstraction (e.g., hierarchy levels), the IRP engine achieves a depth of contextual understanding and security insight that was previously out of reach with existing approaches. This technical progress directly leads to enhanced system performance, stronger data protection, and more efficient resource utilization within the networked environment. Furthermore, the IRP engine’s capability to generate specific, actionable recommendations for addressing security exposures and misalignments showcases its real-world impact and essential role in solving complex cybersecurity challenges that organizations face today.

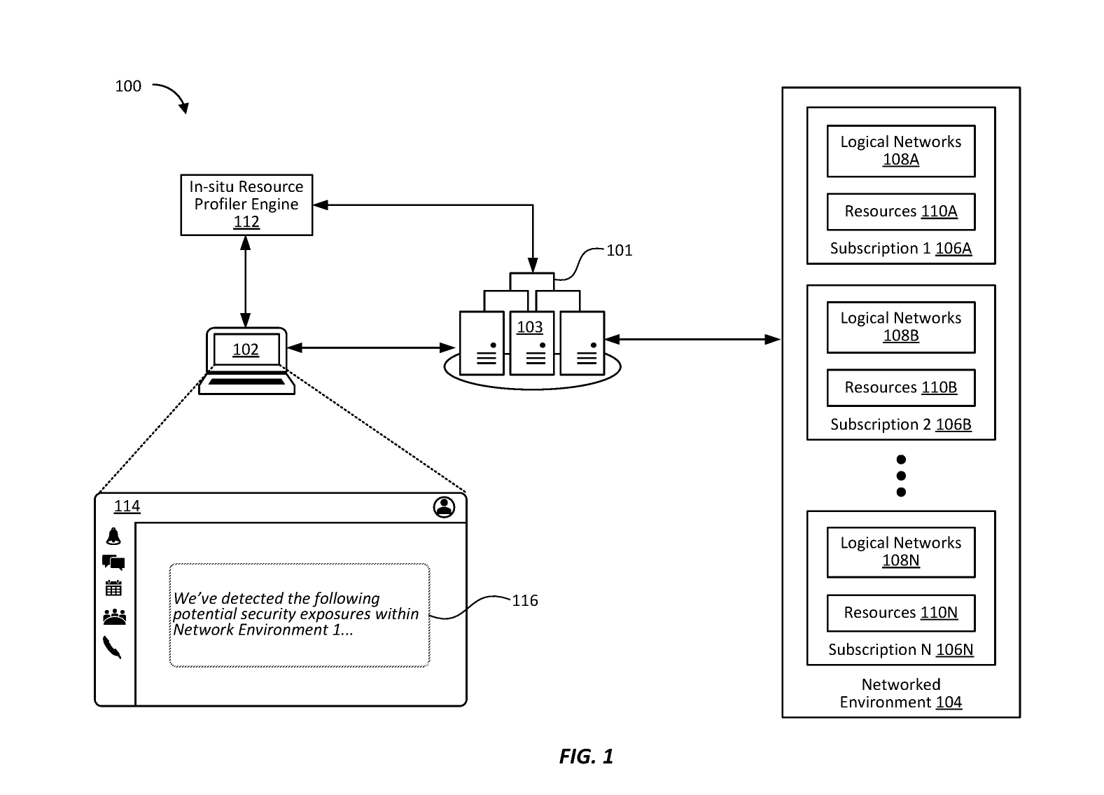

Turning now to FIG. 1, an example environment 100 for monitoring the security posture of a networked environment 104 is illustrated, according to various embodiments. The environment 100 includes an application platform 101 and at least one client device 102. A user operating the client device 102, such as a security team member, may access the application platform 101 to monitor, identify, and manage potential security exposures within the networked environment 104. The application platform 101 provides the tools and services necessary to evaluate security configurations, detect vulnerabilities, and present actionable insights to the user through the client device 102.

The client device 102 may include a wide range of computing and communication devices, such as personal computers, tablets, smartphones, gaming consoles, wearable devices, Internet of Things (IoT) devices, or other network-enabled hardware. The client device 102 is configured to execute software applications, web-based interfaces, or other user interfaces that enable interaction with remote services, including the application platform 101, for security monitoring and management tasks. Through these interfaces, a user may submit queries, review security alerts, configure monitoring preferences, and respond to detected security exposures.

To facilitate these operations, the client device 102 is in operable communication with the application platform 101 via one or more communication networks. Such networks may include local area networks (LANs), wide area networks (WANs), cellular networks (e.g., 4G/5G), Wi-Fi, or the Internet. Communication between the client device 102 and the application platform 101 may utilize secure communication protocols to protect data integrity and confidentiality. This operable communication enables real-time or near-real-time interaction, allowing the security team member to effectively monitor and manage the security posture of the networked environment 104.

The application platform 101 includes one or more server computers 103, which provide the computational, storage, and networking infrastructure required to deploy and operate various security monitoring services. The server computers 103 may be implemented using physical hardware, virtual machines, containers, or cloud-based instances, and are configured to receive and process requests from client devices 102. These backend systems handle tasks such as aggregating telemetry data, performing threat detection, enforcing security policies, and generating alerts or recommendations based on observed conditions within the networked environment 104.

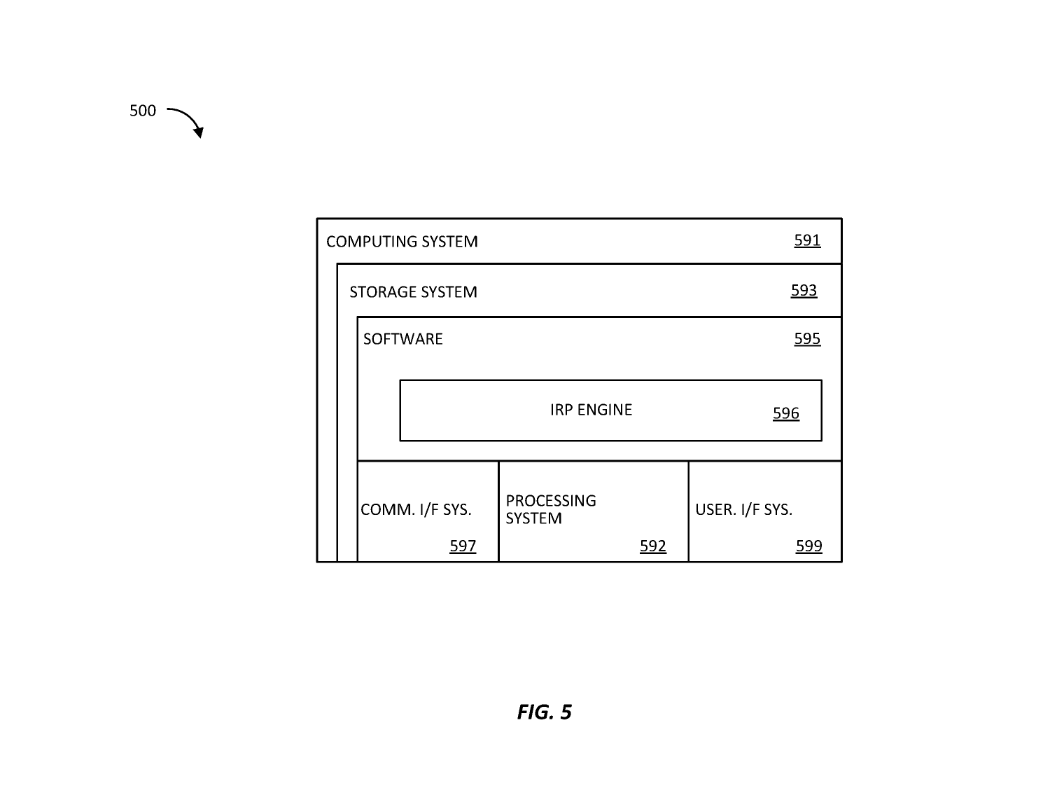

As further depicted in FIG. 5, a generalized computing architecture (e.g., computer system 591) may represent both the client device 102 and the server computers 103. This architecture includes components such as processors, memory, storage, and communication interfaces, which may be configured differently depending on whether the system is operating in a client role or a server role within the environment 100. For example, the client device 102 may prioritize user interface capabilities and network connectivity, while the server computers 103 may emphasize high-performance processing, data storage, and scalable communication infrastructure to support the demands of the application platform 101.

In various embodiments, the client device 102 interacts with the application platform 101, including server computers 103, to continuously monitor the security posture of a networked environment 104. The client device 102 may transmit monitoring requests, configuration updates, or security queries to the application platform 101, which processes these inputs and returns relevant security data or alerts. This interaction may occur through a graphical user interface (GUI), command-line interface (CLI), or application programming interfaces (APIs) exposed by the application platform 101.

The networked environment 104 may represent a complex, cloud-based infrastructure spanning multiple administrative domains and resource groupings. In the illustrated example, the networked environment 104 corresponds to a cloud computing environment managed by a cloud service provider (CSP), such as Microsoft Azure®. This environment may host a wide variety of virtualized resources, services, and network configurations deployed across different organizational units, projects, or business functions. The networked environment 104 may include compute instances, storage services, databases, containerized applications, serverless functions, and other cloud-native services, all operating within virtualized network constructs.

It should be appreciated that while the illustrated example provided herein focuses on the cloud-based networked environment 104, including multiple subscriptions 106A-N as commonly implemented in cloud service provider infrastructures, the concepts and embodiments described are equally applicable to other types of networked environments that incorporate hierarchical structures. For example, the techniques disclosed herein may be applied to on-premises data center environments, where hierarchical levels may include physical servers, virtualization clusters, network segments, and individual compute or storage resources. Similarly, hybrid cloud environments—combining cloud-based subscriptions with on-premises infrastructure—may implement hierarchy levels spanning tenant boundaries, virtual networks, subnets, and managed resources across both platforms. In addition, enterprise networks utilizing software-defined networking (SDN) architectures, campus networks, or multi-tenant colocation facilities may also present hierarchical configurations involving logical partitions, VLANs, routing domains, and segmented resource pools. Accordingly, although a cloud-specific example is depicted for illustrative purposes, the systems and methods described herein are broadly applicable to any networked environment where resources, access controls, and network configurations are organized across multiple hierarchical levels.

To manage scalability and isolation, the networked environment 104 is organized into the subscriptions 106A-N. Each subscription 106 may represent a logical boundary defined by the CSP for purposes of billing, access control, and resource management. For example, different subscriptionsmay be allocated for development, testing, and production environments, or assigned to distinct departments within an enterprise. The application platform 101 is configured to interface with these subscriptions 106A-N via cloud APIs, security monitoring agents, or CSP-native integrations to collect telemetry and configuration data necessary for security analysis.

Within each subscription 106A-N, the networked environment 104 includes one or more logical networks 108A-N and associated resources 110A-N. The logical networks 108A-N may comprise virtual private clouds (VPCs), virtual networks (VNETs), subnets, routing tables, and network security groups (NSGs), which collectively define the communication pathways, segmentation policies, and perimeter defenses within the cloud environment. These logical networks provide isolation between workloads and enforce network-level security controls that govern how resources communicate internally and externally.

The resources 110A-N within each subscription 106 may include a variety of cloud-based assets such as virtual machines (VMs), databases, storage accounts, load balancers, containers, and other services provisioned within the logical networks 108A-N. These resources are often dynamic, with instances being frequently created, modified, or terminated in response to operational demands. As such, maintaining continuous visibility into the security configurations and exposure risks of these resources may be difficult.

Through its interaction with the application platform 101, the client device 102 enables a security team member to monitor the various subscriptions 106A-N, logical networks 108A-N, and resources 110A-N within the networked environment 104 in real time or near-real time. The application platform 101 aggregates telemetry and configuration data from across the networked environment 104, analyzes resource settings, access controls, and network topologies. This security information may be presented to the client device 102 in the form of alerts, dashboards, compliance reports, or automated recommendations, allowing the security team member to take timely corrective actions across the distributed cloud infrastructure.

In some embodiments, the application platform 101 may generate a contextual security representation of the networked environment 104 to enhance visibility and understanding of potential risks. For example, the application platform 101 may construct an Exposure Knowledge Graph that dynamically maps all resources 110A-N within the networked environment 104, including their relationships, configurations, access controls, and associated security exposures. This graph-based representation enables the correlation of seemingly disparate data points, allowing the identification of complex risk patterns, such as transitive access exposures, misconfigured network paths, or privilege escalation opportunities. By leveraging such a contextual model, the security team member can more effectively prioritize remediation efforts based on the interconnected nature and criticality of resources 110A-N within the networked environment 104.

Despite the use of the contextual security representation, understanding the precise role of a given resource within the broader networked environment 104 remains a challenge for security teams. While contextual security representations can effectively map resources, their configurations, relationships, and exposures, they do not inherently convey the intended function or operational context of each resource. For example, two virtual machines may appear structurally similar within the contextual security representation, yet serve entirely different purposes—one operating as a public-facing web server and the other as a backend database server restricted to internal access. Without clear visibility into the intended role of each resource, security teams may struggle to accurately assess whether a particular configuration represents a valid deployment or a potential security misconfiguration.

Determining the design pattern associated with a specific resource further complicates this challenge. A design pattern refers to an established configuration or deployment model that aligns with security best practices and operational requirements for a given resource type and role within the networked environment 104. Identifying whether a resource adheres to an expected design pattern requires correlating information across multiple dimensions, including network segmentation, access controls, resource configurations, and inter-resource relationships. This task is exacerbated in dynamic and large-scale networked environments, where resources are frequently provisioned, modified, or decommissioned.

Ensuring that a resource’s design pattern is consistently applied and enforced across the various hierarchy levels of the networked environment 104 introduces additional complexity. Each hierarchy level—such as subscriptions 108A-N, resource groups, virtual networks, subnets, and individual resources—may impose distinct policies, access controls, and configurations that collectively define the security posture of a resource. Variations in these controls across different segments of the networked environment 104 can lead to inconsistencies, where identical resource types may exhibit divergent security characteristics depending on their placement within the hierarchy. As a result, maintaining uniform adherence to design patterns across a distributed and multi-hierarchy leveled infrastructure of networked environments 104 requires continuous validation and presents an ongoing challenge for security teams tasked with safeguarding the environment.

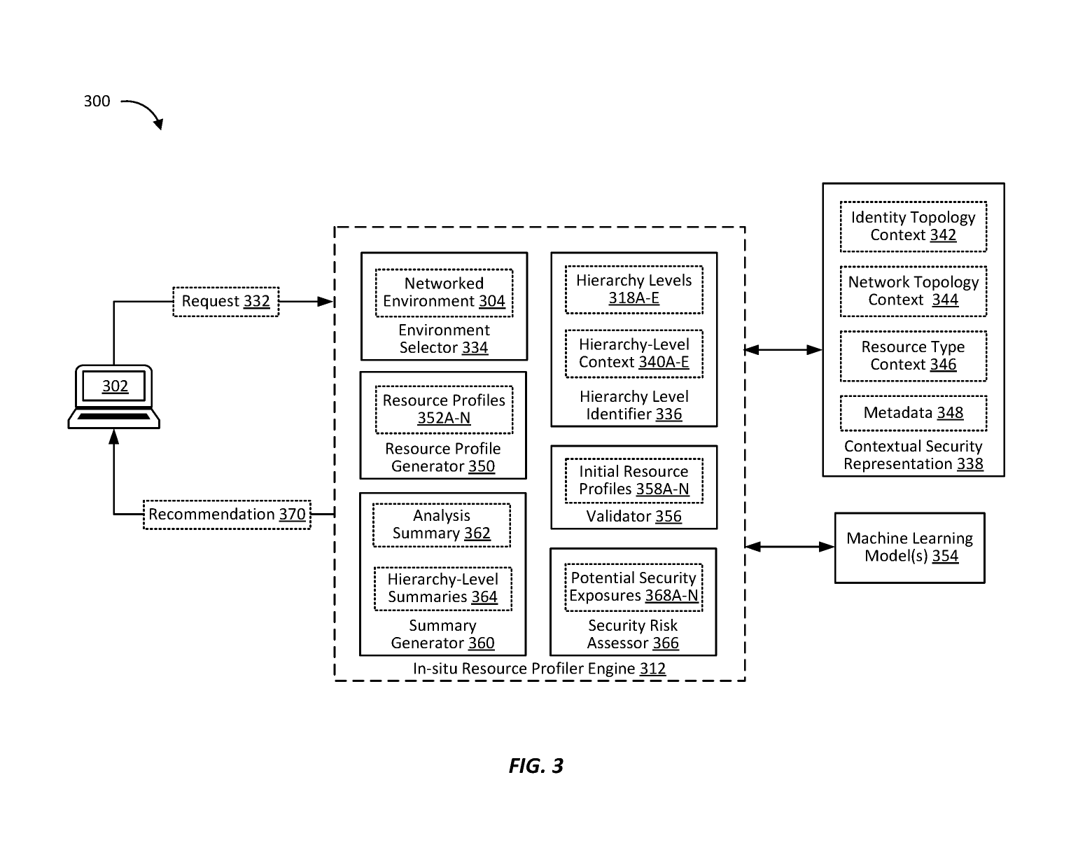

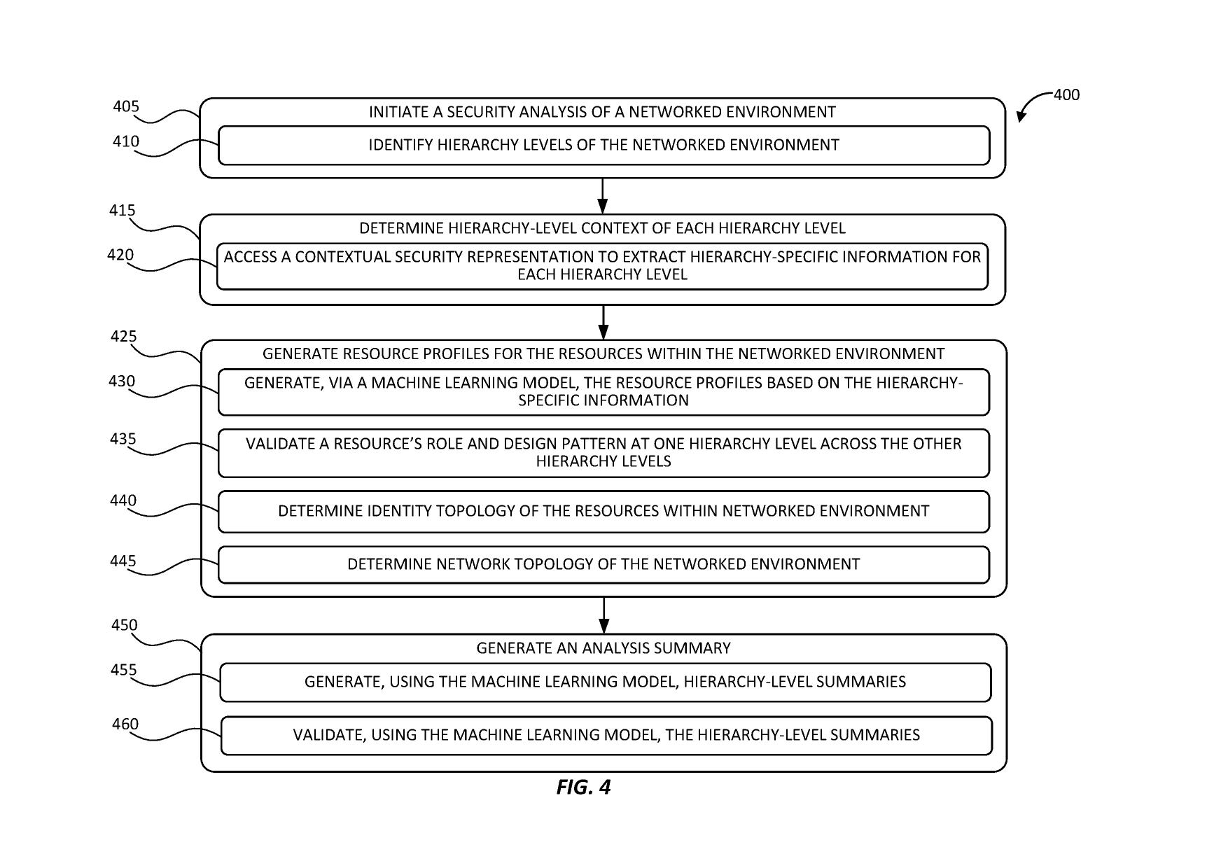

To determine a resource's 110A-N role and design pattern within the networked environment 104, an in-situ resource profiler (IRP) engine 112 is leveraged within the environment 100. As will be described in greater detail below with respect to FIGS. 3-4, the IRP engine 112 may identify and analyze the resources 110A-N within the networked environment 104, sometimes periodically or in an on-going manner, to determine hierarchy-level context and generate resource profiles that capture the roles and design patterns of each resource 110A-N across the various hierarchy levels of the networked environment 104. The IRP engine 112 may then validate these resource profiles across different hierarchy levels and generate comprehensive summaries.

In some cases, the IRP engine 112 may detect potential security exposures, misconfigurations, or deviations from expected design patterns based on the resource profiles and their relationships across hierarchy levels. If such issues are identified, the IRP engine 112 may notify the client device 102. For example, as illustrated, the IRP engine 112 may provide, via a user interface 114, a notification 116 indicating that one or more potential security exposures were detected within the networked environment 104. In some cases, along with the notification 116, the IRP engine 112 may generate targeted recommendations for addressing identified security exposures, misalignments, or discrepancies in design patterns and resource roles across hierarchy levels, providing specific actions to rectify misconfigurations, adjust access controls, or realign resources with expected design patterns.

As shown, the IRP engine 112 may be in operable communication with the client device 102 and the application platform 101. As such, the client device 102 may interact with the IRP engine 112 to determine the security posture of the networked environment 104. As will be described below, the IRP engine 112 may, in turn, interact with the application platform 101 to gather or determine various information about the resources 110A-N within the networked environment 104. This information may include resource configurations, network topology, access controls, and other contextual data necessary for generating comprehensive resource profiles. The IRP engine 112 may utilize APIs, secure communication protocols, or dedicated monitoring agents to collect data from the application platform 101 and the networked environment 104. This data collection process may occur in real-time or at scheduled intervals, ensuring that the IRP engine 112 maintains an up-to-date understanding of the dynamic networked environment 104.

It should be appreciated that while the IRP engine 112 is illustrated as separate from the application platform 101, in some cases, the IRP engine 112 may be hosted or otherwise part of the application platform 101. This integration may allow for more efficient data processing and analysis, leveraging the platform's existing infrastructure and security measures. While in other cases, the IRP engine 112 may be hosted by a third party or locally executed by the client device 102. These deployment options provide flexibility to organizations in terms of data sovereignty, compliance requirements, and operational preferences. Regardless of its deployment model, the IRP engine 112 maintains its core functionality of analyzing resources 110A-N across hierarchy levels, generating resource profiles, detecting security exposures, and providing actionable recommendations to enhance the overall security posture of the networked environment 104.

The IRP engine 112 provides numerous advantages to security teams, such as those associated with the client device 102, by offering a structured understanding of how the resources 110A-N are intended to be configured and operate within their respective contexts in the networked environment 104. By recognizing design patterns, the IRP engine 112 establishes baselines for expected configurations, network placements, and access controls associated with specific resource roles. This contextual awareness enables the IRP engine 112 to detect discrepancies where resources 110A-N deviate from their intended design patterns, highlighting potential misconfigurations, policy violations, or anomalous deployments. As a result, security teams using the IRP engine 112 are better equipped to quickly pinpoint resources 110A-N that present elevated risk or potential security exposures, streamlining the process of threat identification and remediation across complex and dynamic networked environments. The IRP engine 112's ability to analyze resources across multiple hierarchy levels and validate resource profiles enhances its effectiveness in identifying and addressing security issues in a comprehensive manner.

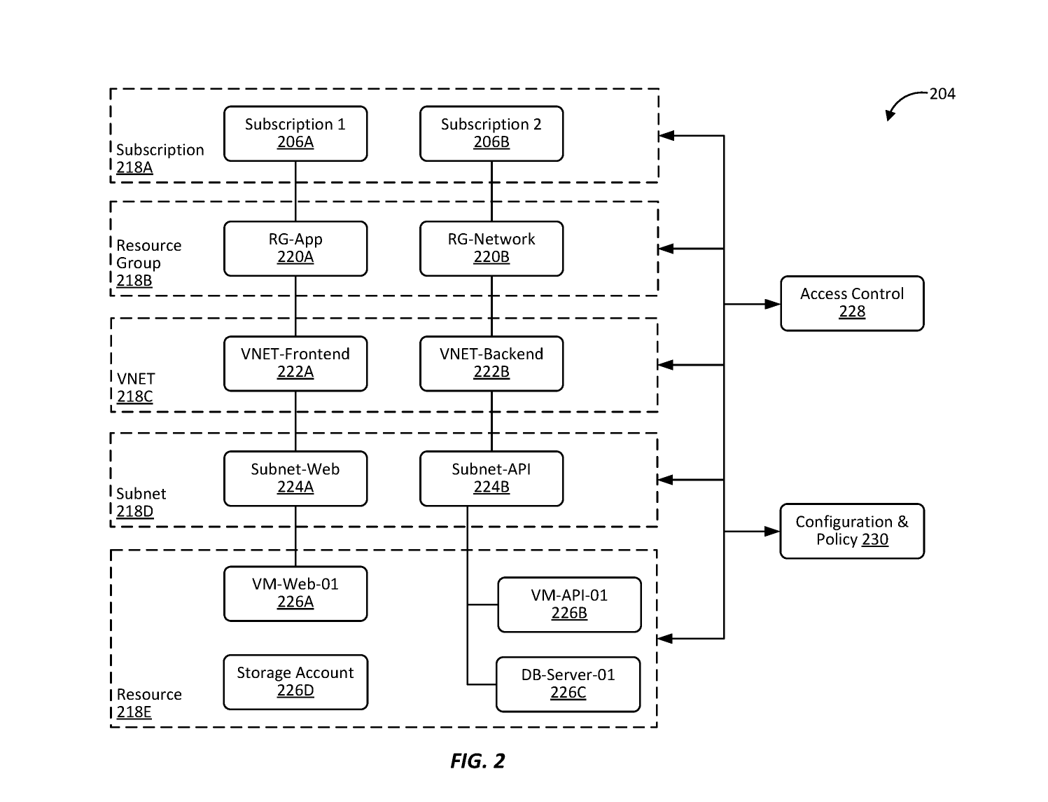

Turning now to FIG. 2, an example networked environment 204 is illustrated, according to various embodiments herein. As shown, the networked environment 204, which may be the same or similar to the networked environment 104, may be organized across multiple hierarchy levels 218A-E. A hierarchy level, as used herein, refers to a logical layer within the networked environment 204 that defines how resources, such as the resources 110A-N, are structured, grouped, and managed. Each hierarchy level 118A-E may represent a distinct scope of administrative control, network segmentation, or resource deployment, where access controls 228, configurations, and policies 230 may be applied independently or inherited by lower levels.

In the illustrated example, the networked environment 204 includes five hierarchy levels 218A-218E. At the top, the hierarchy level 218A represents the subscription level, which serves as a high-level boundary for resource management, billing, and access governance within a cloud-based infrastructure. In this example, two subscriptions are shown: Subscription 1 206A and Subscription 2 206B. Beneath the subscription level, the hierarchy level 218B corresponds to the resource group level, where resources within a subscription are logically grouped for simplified management and the application of access controls. For instance, RG-App 220A and RG-Network 220B illustrate two resource groups associated with the respective subscriptions 206A-B.

Proceeding further, the hierarchy level 218C represents the virtual network (VNET) level, where network segmentation and communication boundaries are defined. In this example, the VNET level 218C includes a VNET-Frontend 222A and a VNET-Backend 222B, each of which providing isolated networking environments within their respective resource groups 220A-B. Nested within each VNET 222A-B is a hierarchy level 218D, which corresponds to the subnet level. Subnets, such as a Subnet-Web 224A and a Subnet-API 224B, provide more granular network segmentation within the VNETs, allowing for controlled routing and traffic filtering between different resource types.

At the lowest illustrated layer, the hierarchy level 218E represents the resource level, where individual compute, storage, and data resources are deployed. As illustrated, a VM-Web-01 226A, a VM-API-01 226B, a DB-Server-01 226C, and a Storage Account 226D are examples of resources operating within the defined subnet and network structures. These resources, which may be representative of the resources 110A-N, may include virtual machines, databases, storage services, and other cloud-native components that execute workloads and store data within the networked environment 204.

Additionally, FIG. 2 illustrates how access controls 228 and configuration/policy 230 mechanisms may govern one or more of the hierarchy levels 218A-218E. Access controls 228 may be applied at various levels to enforce role-based access, identity management, and permissions across the subscriptions 206A-B, the resource groups 220A-B, the networks 22A-B and 224A-B, and the individual resources 226A-D. Similarly, configuration and policy controls 230 may define security baselines, compliance requirements, and operational constraints, ensuring that resources 226A-D and network configurations adhere to organizational or regulatory standards throughout the hierarchical structure of the networked environment 204.

It should be appreciated that while FIG. 2 illustrates a limited number of elements for clarity and ease of understanding—such as four resources 226A-D, two subscriptions 206A-B, two resource groups 220A-B, two virtual networks (VNETs) 222A-B, and two subnets 224A-B—a typical networked environment 204 in real-world implementations may include hundreds or even thousands of resources distributed across the various hierarchy levels 218A-E. The simplified depiction in FIG. 2 is intended to illustrate the hierarchical structure and relationships between different types of resources and organizational constructs, without representing the full scale or complexity commonly found in enterprise environments. In practice, such networked environments 204 would feature significantly more subscriptions, resource groups, networks, subnets, and resources, interconnected across multiple hierarchy levels. This greater scale and complexity further underscores the need for systematic approaches to resource profiling, design pattern identification, and security exposure detection as described herein.

Within the hierarchy levels 218A-E of the networked environment 204, resources 226A-D can assume a wide range of operational roles and configurations that vary based on their placement within the hierarchy. For example, a virtual machine deployed in a public-facing subnet at hierarchy level 218D may operate as a web server, while an identical virtual machine type placed within a backend subnet may function as a database host or internal application server. This variability highlights how the same resource type can fulfill distinct purposes depending on its contextual deployment. Further adding to this complexity, access controls 228 and configuration policies 230 are applied differently across hierarchy levels 218A-E, reflecting varying security requirements and operational constraints. Access controls 228 may govern identity management, role-based access, and permissions at multiple hierarchy levels 218A-E, including subscriptions 206A-B, resource groups 220A-B, networks 222A-B, and individual resources 226A-D. Similarly, configuration and policy controls 230 may enforce security baselines, compliance mandates, and design standards that differ across each hierarchical level 218A-E. As a result, identical resources can be subject to distinct security policies, network configurations, and operational expectations solely based on their hierarchical positioning within the networked environment 204.

As noted above, the dynamic and multi-faceted nature of resource roles and design patterns across hierarchy levels 218A-E presents challenges for security teams, particularly in detecting security exposures that arise from contextual nuances. A resource 226A-D that appears properly configured when viewed in isolation may introduce vulnerabilities once its role, relationships, or hierarchical placement are taken into account. Discrepancies in configuration settings, inconsistent application of access controls 228, or deviations from intended design patterns can lead to latent security gaps that evade detection by conventional monitoring tools focused on static configurations. These challenges are further exacerbated by the fluidity of modern networked environments 204, where the resources 226A-D are continuously provisioned, modified, or retired in response to shifting business and operational demands. This constant state of change complicates efforts to maintain consistent security postures and underscores the necessity for context-aware analysis capable of understanding how resource roles, configurations, and design patterns interact across hierarchical structures.

Turning now to FIG. 3, an example environment 300 in which an IRP engine 312 is leveraged for determining a security posture of a networked environment is illustrated, according to an embodiment herein. For ease of explanation, FIG. 3 is described with reference to FIG. 4, which illustrates a process 400 for providing an IRP engine and one or more of its functions, according to an embodiment herein. While FIG. 4 is described in relation to FIG. 3, it should be appreciated that the process 400 is equally applicable to the remaining figures and components therein.

As shown, the IRP engine 312, which may be the same or similar to the IRP engine 112, is in operable communication with a client device 302, which may be the same or similar to the client device 102. In some embodiments, the client device 302 may correspond to a security team member who is monitoring a networked environment, such as the networked environment 204. The client device 302 may initiate a security analysis of a networked environment 304 (405) by submitting a request 332 to the IRP engine 312. This request 332 instructs the IRP engine 312 to perform the security analysis of the networked environment 304. In other embodiments, the IRP engine 312 may automatically or periodically perform a security analysis of the networked environment 304 without explicit user initiation.

The IRP engine 312 includes an environment selector 334, which is responsible for identifying the specific networked environment to be analyzed. When processing the request 332, the environment selector 334 determines which networked environment to analyze based on the information provided. In some cases, the request 332 may explicitly identify the networked environment 304. Alternatively, the environment selector 334 may identify the networked environment 304 based on metadata associated with the client device 302, such as user identity or organization information. This flexibility allows the IRP engine 312 to adapt to different operational contexts and user requirements when initiating security analyses.

Responsive to receiving the request 332 and/or identifying the networked environment 304 for analysis, the IRP engine 312 may identify the hierarchy levels 318A-E of the networked environment (410). In particular, the IRP engine 312 may include a hierarchy level identifier 336 that identifies the hierarchy levels 318A-E within the networked environment 304. The hierarchy levels 318A-E, which may be the same or similar to the hierarchy levels 218A-E may correspond to the organizational architecture of resources within the networked environment 304. These hierarchy levels may include, for example, a subscription level 318A representing high-level boundaries for resource management and billing within a cloud-based infrastructure, a resource group level 318B where resources are logically grouped for simplified management, a VNET level 318C defining network segmentation and communication boundaries, a subnet level 318D providing more granular network segmentation within VNETs, and a resource level 318E representing individual compute, storage, and data resources such as virtual machines, databases, and storage services. Each hierarchy level 318A-E may have distinct access controls and configuration policies applied to it, creating a structured framework for resource management across the networked environment 304.

To identify the hierarchy levels 318A-E, the hierarchy level identifier 336, in some embodiments, may access a contextual security representation 338. The contextual security representation 338 may be a graphical representation of the networked environment 304 that contains all resources within the networked environment 304, all exposures identified for these resources, and the contextual connections between the resources. This comprehensive graph structure allows for a holistic view of the environment's security posture and resource relationships.

An example of such a contextual security representation 338 is an Exposure Knowledge Graph (EKG). The EKG serves as a tool for visualizing and analyzing the complex interconnections within the networked environment 304. The EKG may map out all resources, their configurations, and their relationships, while also incorporating identified security exposures and vulnerabilities. As such, the contextual security representation 338 enables the IRP engine 312 to traverse the hierarchical structure of the networked environment 304, identifying the various levels 318A-E and their associated resources.

In some embodiments, the contextual security representation 338 may be generated by a third-party service specializing in security analysis and visualization of networked environments. These third-party providers may offer sophisticated tools and algorithms to create comprehensive graphical representations of complex infrastructures, leveraging their expertise in security assessment and data visualization. Alternatively, in other cases, a related service or platform, such as the application platform 101, may generate the representation 338 as part of its integrated security and management offerings. When generated by the application platform 101, the contextual security representation 338 may benefit from direct access to real-time data and configurations within the networked environment 304, potentially providing more up-to-date and accurate representations. Regardless of the source, the IRP engine 312 may be designed to interface with and interpret the contextual security representation 338, extracting the necessary information to identify and analyze the hierarchy levels 318A-E within the networked environment 304.

Once the hierarchy levels 318A-E are identified, the hierarchy level identifier 336 may determine hierarchy-level context 340A-E for each hierarchy level 318A-E (415). To determine the hierarchy-level context 340A-E for the hierarchy levels 318A-E, the hierarchy level identifier 336 may access the contextual security representation 338 to extract hierarchy-specific information (420). Specifically, the hierarchy level identifier 336 may query the contextual security representation 338 to extract hierarchy-specific information for each hierarchy level 318A-E, which may include but is not limited to identify topology context 342, network topology context 344, resource type context 346, and resource metadata 348.

The extraction process for hierarchy-specific information may be performed in various ways depending on the implementation. In some embodiments, the hierarchy level identifier 336 queries the contextual security representation 338 for each hierarchy level 318A-E individually, allowing for detailed, level-specific analysis. This approach may be particularly useful when dealing with complex environments where each level requires unique consideration. In other embodiments, the hierarchy level identifier 336 may query the contextual security representation 338 for the hierarchy-level contexts 340A-E of multiple hierarchy levels 318A-E simultaneously. This method can be more efficient in terms of processing time, especially in large-scale environments with numerous hierarchy levels 318A-E.

To facilitate efficient and targeted retrieval of relevant data (e.g., the hierarchy-specific information), particularly when dealing with large-scale log analytics and time-series data common in complex networked environments, some implementations may utilize hardcoded KQL (Kusto Query Language) queries. KQL queries may be specifically configured to extract hierarchy-specific context 340A-E from the contextual security representation 338, allowing the IRP engine 312 to quickly parse and analyze vast amounts of data across multiple hierarchy levels 318A-E. By leveraging KQL's syntax and optimized query processing capabilities, the hierarchy level identifier 336 may efficiently extract and structure the necessary hierarchy-specific information to build comprehensive hierarchy-level contexts 340A-E, even in highly complex and dynamic networked environments.

As noted above, the hierarchy-specific information may include various relevant data about resources at a given hierarchy level 318A-E. In some embodiments, the hierarchy-specific information may include identity topology context 342, network topology context 344, and resource type context 346. In some cases, the hierarchy-specific information may also include the resource metadata 348, while in other embodiments the resource metadata 348 may be extracted in a subsequent step. The identity topology context 342 may include outgoing permissions from resources at a particular hierarchy level 318A-E, such as access rights and role assignments. The network topology context 344 may include incoming and outgoing network connections for resources within a respective hierarchy level 318A-E, detailing communication paths and potential exposure points. The resource type context 346 may identify the types and classifications of resources present in a respective hierarchy level 318A-E, such as virtual machines, databases, or storage accounts. Additionally, resource metadata 348 may provide supplementary information about each resource, including tags, configurations, and operational status. This comprehensive set of contextual information enables the IRP engine 312 to develop a detailed understanding of the resources and their relationships within each hierarchy level 318A-E.

The hierarchy-level context 340A-E may represent the real-time context of the resources within the networked environment 304. As noted above, the “in-situ" nature of the IRP engine 312 allows it to analyze resources in their native operational context, observing their behavior, interactions, and configurations as they exist and function within the live networked environment 304. This real-time, contextual analysis enables the IRP engine 312 to fully appreciate and understand the dynamic nature of resources, capturing their evolving roles and relationships in the networked environment 304 as it operates live. The extracted hierarchy-specific information reflects the current state of the networked environment 304, providing up-to-date insights into resource configurations, access controls, and potential security exposures. By leveraging this real-time data, the IRP engine 312 can detect and respond to security issues as they emerge, rather than relying on potentially outdated snapshots of the environment. This in-situ approach ensures that the hierarchy-level context 340A-E and subsequent analysis remain relevant and accurate, even in rapidly evolving cloud infrastructures where resources are frequently provisioned, modified, or decommissioned.

Responsive to determining the hierarchy-level context 340A-E for the hierarchy levels 318A-E, the IRP engine 312 may generate resource profiles 352A-N for resources within the networked environment 304 (435). In particular, the IRP engine 312 may include a resource profile generator 350 that generates the resource profiles 352A-N for the resources within the networked environment 304 based on the hierarchy-level context 340A-E. As will be expanded on in greater detail below, the resource profiles 352A-N may identify a resource role and/or design pattern of a respective resource, such as the resources 110A-N, within the networked environment 304.

To generate the resource profiles 352A-N, the resource profile generator 350 may be in operable communication with one or more machine learning (ML) model(s) 354 (430). The ML model(s) 354 may be trained on historical data of resource configurations, roles, and design patterns across various networked environments to recognize and classify resources based on their characteristics and context. The ML model(s) 354 may employ techniques such as supervised learning, unsupervised learning, or reinforcement learning to analyze the hierarchy-level context 340A-E and determine appropriate resource profiles. The ML model(s) 354 may include, but are not limited to, neural networks, decision trees, random forests, or support vector machines, each optimized for different aspects of resource profiling.

It should be appreciated that while the ML model(s) 354 is illustrated as separate from the IRP engine 312, in some embodiments, the ML model(s) 354 may be integrated with the IRP engine 312, allowing for seamless processing and potentially faster analysis. In other embodiments, the ML model(s) 354 may be separate from the IRP engine 312, such as hosted by a third party. This separation can provide benefits such as access to more powerful computational resources, regularly updated models trained on diverse datasets, or specialized expertise in machine learning for security applications. Regardless of the deployment model, the IRP engine 312 leverages the ML model(s)’s 354 to accurately identify resource roles and design patterns within the complex, multi-level hierarchy of the networked environment 304.

The resource profile generator 350 may leverage the ML model(s) 354 to analyze the hierarchy-level context 340A-E and determine the roles and design patterns of resources within each hierarchy level 318A-E. In some implementations, the resource profile generator 350 may feed the hierarchy-level context 340A-E to the ML model(s) 354 for each level 318A-E individually. This approach allows for a detailed, level-specific analysis, where the ML model(s) 354 can focus on the unique characteristics and constraints of each hierarchy level. The ML model(s) 354 may then process this context and output a respective resource's role and design pattern within that specific hierarchy level.

Alternatively, in other cases, the resource profile generator 350 may feed the hierarchy-level context 340A-E for all of the hierarchy levels 318A-E to the ML model(s) 354 simultaneously. This holistic approach enables the ML model(s) 354 to consider the broader context of the entire networked environment 304 when determining resource roles and design patterns. By analyzing the relationships and patterns across multiple hierarchy levels at once, the ML model(s) 354 may identify more complex or nuanced resource roles that span multiple levels of the hierarchy.

In both scenarios, the ML model(s) 354 analyzes the provided hierarchy-level context 340A-E, which may include the identity topology context 342, network topology context 344, resource type context 346, and resource metadata 348. The ML model(s) 354 may then process this information using their trained algorithms to classify and characterize each resource. For example, the ML model(s) 354 may analyze naming conventions and tagging patterns associated with the resources, such as considering how naming conventions and tags align with or suggest specific resource functions or architectural designs. The ML model(s) 354 may also analyze historical usage data associated with the resources as provided in the hierarchy-level context 340A-E (e.g., network topology context 344) to generate an output. The output from the ML model(s) 354 typically includes a predicted role (e.g., web server, database, load balancer) and an identified design pattern (e.g., three-tier architecture, microservices pattern) for each resource within the analyzed hierarchy levels. This output, including insights derived from the hierarchy-level context 340A-E, may then be used by the resource profile generator 350 to construct comprehensive resource profiles 352A-N that capture the function and configuration of each resource within the context of its hierarchy level(s) in the networked environment 304.

In some embodiments, the IRP engine 312 may validate the resource profiles 352A-N (435). For example, a resource's role and design pattern identified at one hierarchy level 318A-E may be validated across the remaining hierarchy levels 318A-E. As illustrated, the IRP engine 312 may include a validator 356 that compares a resource's role and design pattern identified at one hierarchy level 318A-E to the role and design pattern identified for that resource at all other hierarchy levels 318A-E. This cross-level validation process ensures consistency and accuracy in resource profiling across the entire networked environment 304.

The validator 356 may analyze various contextual elements to perform this validation, including but not limited to naming conventions, tagging patterns, and configurations of neighboring resources across all hierarchy levels. For example, the validator 356 may examine the naming conventions of all neighboring resource groups to help identify or confirm the role of a current resource group. Similarly, it may analyze the network topology context 344 and access patterns across multiple levels to validate a resource's identified design pattern.

If discrepancies are detected between the roles or design patterns identified at different hierarchy levels 318A-E, the validator 356 may initiate a re-evaluation process. In such cases, the validator 356 may communicate with the ML model(s) 354, providing all the hierarchy-level contexts 340A-E collectively, rather than individually. The ML model(s) 354 then analyze this hierarchy-level contexts 340A-E comprehensively, in some embodiments, taking into account initial resource profiles 358A-N for resources as well as the context across all hierarchy levels 318A-E. The initial resource profiles 358A-N represent the resource profiles of the resources generated during a previous evaluation process. By considering this holistic view, including both current and historical data, the ML model(s) 354 may generate a new verdict regarding the role and design pattern of a respective resource in question. This approach allows for a more nuanced and context-aware determination, potentially resolving inconsistencies that arise from level-specific analyses. The resulting refined resource profiles 352A-N more accurately reflect the true function and configuration of resources within the complex, multi-level structure of the networked environment 304, thereby enhancing the overall accuracy and reliability of the IRP engine's 312 security analysis.

In some embodiments, the IRP engine 312 may determine an identity topology of the resources within the networked environment 304 (440) and/or determine a network topology of the networked environment 304 (445). The identity topology may represent the relationships between resources based on access rights, permissions, and role assignments across the hierarchy levels 318A-E. As described below, the identity topology and/or network topology play a role in understanding potential security exposures related to over-privileged accounts or improper access controls for the resources. By determining both the identity and network topologies, the IRP engine 312 can provide a more comprehensive understanding of the security posture of the networked environment 304. This information enhances the accuracy of resource profiling and enables more effective detection of potential security exposures that may arise from misconfigurations in either identity management or network architecture.

To determine the identity topology, the IRP engine 312 may analyze both the identity topology context 342 extracted from the contextual security representation 338 and the relevant information from the resource profiles 352A-N. This analysis may involve mapping out the permissions and access rights associated with each resource, identifying trust relationships between resources, and determining the scope of access for various identities across different hierarchy levels 318A-E. The resource profiles 352A-N may provide additional context about each resource's role and design pattern, which can inform the understanding of expected access patterns and trust relationships.

Similarly, for the network topology, the IRP engine 312 may leverage both the network topology context 344 from the contextual security representation 338 and the network-related information contained in the resource profiles 352A-N. This allows the IRP engine 312 to construct a comprehensive view of how resources are connected, including information about subnets, virtual networks, and network security groups across the hierarchy levels 318A-E. The resource profiles 352A-N may contribute additional insights into the expected network behavior and configurations for resources based on their identified roles and design patterns.

In some embodiments, the IRP engine 312 may generate an analysis summary 362 of the security analysis of the networked environment 304 (450). In some embodiments, this may include generating a hierarchy-level summary 364 for each of the hierarchy levels 318A-E (455). In particular, the IRP engine 312 may include a summary generator 360 that generates the hierarchy-level summary 364 summarizing the resources at each hierarchy level 318A-E. The hierarchy-level summary 364 may include a comprehensive overview of the resources, their roles, and design patterns within each respective hierarchy level. For each hierarchy level 318A-E, the hierarchy-level summary 364 may contain information such as the total number of resources, distribution of resource types, common design patterns observed, and any potential security exposures or misconfigurations identified. The hierarchy-level summary 364 may also highlight relationships between resources within the same level, as well as connections to resources in adjacent levels. Additionally, the hierarchy-level summary 364 may include statistics on access controls, network configurations, and compliance status relevant to each hierarchy level 318A-E. This detailed summary enables security teams to quickly assess the overall state of resources across different layers of the networked environment 304, facilitating more efficient decision-making and risk management.

Responsive to generating the hierarchy-level summaries 364, the IRP engine 312 may validate them across the networked environment (460). In particular, the validator 356 may validate the hierarchy-level summaries 364 by comparing them across different levels of the hierarchy. To perform this validation, the validator 356 may leverage the ML model(s) 354 to analyze the hierarchy-level summaries 364 collectively. During this validation process, the ML model(s) 354 check for consistency and coherence between the hierarchy-level summaries 364 at different hierarchy levels 318A-E. For example, the ML model(s) 354 may verify that the summary of resource types and roles at a resource group level aligns with the broader context described in the subscription-level summary. The validation also examines whether the distribution of resources, common design patterns, and potential security exposures identified in lower-level summaries are accurately reflected in higher-level summaries.

If the validator 356 detects inconsistencies or mismatches between the hierarchy-level summaries 364 at different levels (e.g., a subscription-level summary indicates primarily production workloads, while a resource group summary within it suggests development environments), the validator 356 may initiate a more comprehensive analysis. In such cases, the validator 356 leverages the ML model(s) 354 to analyze all hierarchy-level summaries 364 collectively, along with the underlying resource profiles 352A-N and initial resource profiles 358A-N. Based on this holistic analysis, the ML model(s) 354 may suggest adjustments to the hierarchy-level summaries 364 to ensure they accurately represent the resource landscape across all hierarchy levels 318A-E. This approach allows for a more nuanced and context-aware validation, potentially resolving discrepancies that arise from level-specific analyses and ensuring a coherent representation of the networked environment across the entire hierarchy.

If the validator 356 detects a discrepancy or mismatch between the hierarchy-level summaries 364 at different levels 318A-E, the IRP engine 312 may generate a notification of the discrepancy. This notification may alert security teams or system administrators to potential inconsistencies in resource classifications, roles, or design patterns across the hierarchy levels 318A-E. For example, if a resource group summary indicates development workloads while its parent subscription summary suggests production environments, the IRP engine 312 would flag this inconsistency. The notification may include details about the specific resources involved, the nature of the discrepancy, and the hierarchy levels where the mismatch was observed, enabling prompt investigation and resolution of potential misconfigurations or security risks.

In some cases, the IRP engine 312 may detect one or more potential security risks 368A-N based on the resource profiles 352A-N and/or the hierarchy-level summaries 364. To perform this detection, the IRP engine 312 may include a security risk assessor 366 that compares the resource configurations, access patterns, and design patterns identified in the resource profiles 352A-N against predefined security policies and best practices. The security risk assessor 366 may also analyze the relationships between resources across different hierarchy levels 318A-E, as described in the summaries 364, to identify potential vulnerabilities or misconfigurations that may not be apparent when examining resources in isolation. Once potential security risks 368A-N are identified, the security risk assessor 366 may rank them by severity using a combination of factors such as the potential impact of exploitation, the likelihood of occurrence, and the criticality of affected resources. This ranking may involve assigning numerical scores or categorical labels (e.g., high, medium, low) to each detected risk.

Based on the security analysis, the security risk assessor 366 may generate one or more recommendations 370 to mitigate identified risks. These recommendations can include specific actions such as reconfiguring resources, modifying network settings, or adjusting access controls. The recommendations 370 may be prioritized according to the severity of the detected exposures, ensuring that critical issues are addressed first. The recommendations 370 may also account for the broader network architecture and security posture across hierarchy levels 318A-E, targeting misalignments in resource roles or discrepancies in design patterns. For instance, if a resource’s function at one level conflicts with expectations at another, the recommendation may propose reconfiguration or realignment of the resource’s role within the hierarchy.

Once generated, the IRP engine 312 may publish an analysis summary 362, including hierarchy-level summaries 364 and the potential security exposures 368A-N. The analysis summary 362, delivered to the client device 302, may incorporate the recommendations 370 with detailed reports of identified discrepancies and potential security exposures 368A-N. The report may highlight inconsistencies between hierarchy levels—such as mismatches in resource classifications or divergent security policies—and provide a prioritized list of vulnerabilities with severity ratings and impact assessments. Additionally, the analysis summary 362 may offer actionable mitigation steps, including configuration updates, access control revisions, or resource reallocation strategies. For complex issues, multiple mitigation paths may be suggested, with visualizations and summary statistics to assist in evaluating and addressing the overall security posture of the networked environment 304.

Referring to FIG. 5, FIG. 5 illustrates a computing system 591 that may be used for providing or interacting with an IRP engine and related functions, as described herein. For example, the client device 102, 302, or other client devices may be or include the computing system 591, while in another example, any of the network devices or application platform 101 may be or include the computing system 591. As illustrated, the computing system 591 includes a processing system 592 that includes a microprocessor and other circuitry that retrieves and executes software 595 from storage system 593. The processing system 592 may be implemented within a single processing device but may also be distributed across multiple processing devices or sub-systems that cooperate in executing program instructions. Examples of the processing system 592 include general purpose central processing units, graphical processing units, application specific processors, and logic devices, as well as any other type of processing device, combinations, or variations thereof.

The storage system 593 may comprise any computer-readable storage media or medium readable by processing system 592 and capable of storing software 595. The storage system 593 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 593 may also include computer readable communication media over which at least some of the software 595 may be communicated internally or externally. The storage system 593 may be implemented as a single storage device but may also be implemented across multiple storage devices or sub-systems co-located or distributed relative to each other. The storage system 593 may comprise additional elements, such as a controller capable of communicating with the processing system 592 or possibly other systems.

The software 595 (including IRP engine 596) may be implemented in program instructions and among other functions may, when executed by the processing system 592, direct the processing system 592 to operate as described with respect to the various operational scenarios, sequences, and processes illustrated herein. For example, the software 595 may include program instructions for implementing an IRP engine and related functions, such as the process 400 as described in FIG. 4. In some cases, the software 595 may cause one or more features of the IRP engine 596 to provide or display respective components to a user via a user interface system 599 inoperable communication with a client device, such as the notification 116 to the client device 102 via the user interface 114.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 595 may include additional processes, programs, or components, such as operating system software, virtualization software, or other application software. The software 595 may also comprise firmware or some other form of machine-readable processing instructions executable by the processing system 592.

In general, the software 595 may, when loaded into the processing system 592 and executed, transform a suitable apparatus, system, or device (of which computing system 591 is representative) overall from a general-purpose computing system into a special-purpose computing system customized to generate features, functionality, and user experiences provided by the IRP engine. Indeed, encoding the software 595 on the storage system 593 may transform the physical structure of the storage system 593. The specific transformation of the physical structure may depend on various factors in different implementations of this description. Examples of such factors may include, but are not limited to, the technology used to implement the storage media of the storage system 593 and whether the computer-storage media are characterized as primary or secondary storage, as well as other factors.

For example, if the computer readable storage media are implemented as semiconductor-based memory, the software 595 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 597 may include communication connections and devices that allow for communication with other computing systems (not shown) over communication networks (not shown). Examples of connections and devices that together allow for inter-system communication may include network interface cards, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 591 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA), graphics processing units (GPUs), or neural processing units (NPUs) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), FPGAs, GPUs, NPUS, and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of which may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a IRP engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer’s specific goals, such as compliance with application- and business-related constraints, and that these specific goals will vary from one implementation to another and from one developer to another.

As used herein, the term “engine” refers to a computer-related entity, including but not limited to a component, module, or system. An engine may be implemented as software running on a general-purpose processor, hardware, firmware, or any combination thereof. For example, an engine can take the form of a process executing on a hardware processor, a hardware-based processor itself, an object, an executable, a thread of execution, a program, or even an entire computing device.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage media comprising processor-executable instructions stored thereon; and a processor coupled to the computer-readable storage media and configured to execute the processor-executable instructions that, when executed by the processor, direct the computing apparatus to at least: access a contextual security representation of a networked environment, wherein the contextual security representation comprises a plurality of resources; identify a plurality of hierarchy levels associated with the plurality of resources within the contextual security representation; determine a plurality of hierarchy-level context for the plurality of hierarchy levels, wherein individual hierarchy-level contexts within the plurality of hierarchy-level context correspond to respective hierarchy levels within the plurality of hierarchy levels; generate a plurality of resource profiles for the plurality of resources based on the hierarchy-level context, wherein a resource profile of the plurality of resource profiles corresponds to a respective resource of the plurality of resources; and publish the plurality of resource profiles for the plurality of resources within the contextual security representation.

Example 2 is the computing apparatus of any previous or subsequent example, wherein the processor-executable instructions, when executed by the processor, further direct the computing apparatus to: generate a plurality of hierarchy-level summaries based on the plurality of resource profiles; and validate, using a machine learning model, the plurality of hierarchy-level summaries across the plurality of hierarchy levels for consistency.

Example 3 is the computing apparatus of any previous or subsequent example, wherein the processor-executable instructions, when executed by the processor, further direct the computing apparatus to: perform a validation process on the plurality of resource profiles across the plurality of hierarchy levels; identify one or more mismatches between a subset of resource profiles at different hierarchy levels based on the validation process; and responsive to identifying the one or more mismatches, update the subset of resource profiles using additional contextual information from the contextual security representation.

Example 4 is the computing apparatus of any previous or subsequent example, wherein the processor is further configured to execute the processor-executable instructions to: identify a first security exposure for a first resource of the plurality of resources based on the plurality of resource profiles and the plurality of exposures provided in the contextual security representation; and generate a recommendation for mitigating the first security exposure, wherein the recommendation incorporates the first resource's position within the plurality of hierarchy levels of the networked environment as represented in the contextual security representation.

Example 5 is the computing apparatus of any previous or subsequent example, wherein: the processor-executable instructions to determine the plurality of hierarchy-level context for the plurality of hierarchy levels, when executed by the processor, further direct the computing apparatus to: query the contextual security representation to extract hierarchy-specific information for each hierarchy level of the plurality of hierarchy levels; the processor-executable instructions to generate the plurality of resource profiles for the plurality of resources based on the hierarchy-level context, when executed by the processor, further direct the computing apparatus to: determine, based on the hierarchy-specific information for the plurality of hierarchy levels, a network topology of the networked environment; and determine, based on the network topology and the hierarchy-specific information, the plurality of resource profiles of the plurality of resources.

Example 6 is the computing apparatus of any previous or subsequent example, wherein the processor-executable instructions to generate the plurality of resource profiles of the plurality of resources based on the plurality of hierarchy-level contexts, when executed by the processor, further direct the computing apparatus to: process, via a machine learning model, each hierarchy-level context of the plurality of hierarchy-level contexts individually to generate a plurality of initial resource profiles corresponding to a subset of resources associated with a respective hierarchy level; validate the initial resource profiles across the plurality of hierarchy levels; and in response to detecting mismatches between hierarchy levels, analyze, via the machine learning model, the plurality hierarchy-level contexts together in view of previous findings to generate a refined resource profile.

Example 7 is a method comprising: identifying, by an in-situ resource profiler (IRP) engine, a plurality of hierarchy levels within a networked environment, wherein the plurality of hierarchy levels define an organizational architecture of a plurality of resources within the networked environment; determining, by the IRP engine, hierarchy-level context of each hierarchy level of the plurality of hierarchy levels; generating, by the IRP engine, a plurality of resource profiles for the plurality of resources within the networked environment, wherein a resource profile of the plurality of resource profiles comprises a resource role and design pattern of a respective resource of the plurality of resources within the networked environment; and detecting, by the IRP engine, one or more potential security exposures within the networked environment based on the plurality of resource profiles.

Example 8 is the method of any previous or subsequent example, wherein: determining, by the IRP engine, the hierarchy-level context of each hierarchy level of the plurality of hierarchy levels comprises: extracting from a contextual security representation, by the IRP engine, hierarchy-specific information for each hierarchy level of the plurality of hierarchy levels; and determining, by the IRP engine, network topology of the networked environment based on the hierarchy-specific information; and generating, by the IRP engine, the plurality of resource profiles for the plurality of resources within the networked environment comprises: determining, by the IRP, a resource role and design pattern for each resource of the plurality of resources based on the network topology and hierarchy-specific information, wherein a resource profile comprises the resource role and design pattern of a respective resource.

Example 9 is the method of any previous or subsequent example, wherein detecting, by the IRP engine, the one or more potential security exposures within the networked environment based on the plurality of resource profiles comprises: comparing, by the IRP engine, the plurality of resource profiles to one or more predefined security policies; identifying, by the IRP engine, a subset of resource profiles that deviate from the predefined security policies; performing, by the IRP engine, a risk analysis on the subset of resource profiles in view of the hierarchy-level context of the plurality of hierarchy levels; and flagging, by the IRP engine, the one or more potential security exposures for the subset of resource profiles based on the risk analysis.

Example 10 is the method of any previous or subsequent example, wherein determining, by the IRP engine, the hierarchy-level context of each hierarchy level of the plurality of hierarchy levels comprises: extracting from a contextual security representation, by the IRP engine, hierarchy-specific information for each hierarchy level of the plurality of hierarchy levels; and determining, by the IRP engine, identity topology of the plurality of resources within the networked environment based on the hierarchy-specific information.

Example 11 is the method of any previous or subsequent example, wherein generating, by the IRP engine, the plurality of resource profiles for the plurality of resources within the networked environment comprises: processing, via a machine learning model, the hierarchy-level context for the plurality of hierarchy levels, wherein the machine learning model outputs a resource role and design pattern for each resource in the plurality of resources; and generating, by the IRP engine, the plurality of resource profiles for the plurality of resources based on the resource role and design pattern outputted by the machine learning model.

Example 12 is the method of any previous or subsequent example, wherein the method further comprises: analyzing, by the IRP engine, a distribution of resource roles and design patterns for the plurality of resources across the plurality of hierarchy levels based on the plurality of resource profiles; identifying, by the IRP engine, common patterns in the plurality of resource profiles within and across the hierarchy levels based on the distribution; determining, by the IRP engine, a plurality of relationships between the resource roles and design patterns of the plurality of resources based on the plurality of resource profiles; and generating, by the IRP engine, a summary of the plurality of resource profiles, wherein the summary comprises the common patterns and plurality of relationships identified for the plurality of resources within the networked environment.

Example 13 is the method of any previous or subsequent example, wherein the method further comprises: generating, by the IRP engine, one or more recommendations for resource allocation and resource configuration for the plurality of resources based on the summary.

Example 14 is the method of any previous or subsequent example, wherein generating, by the IRP engine, the plurality of resource profiles for the plurality of resources within the networked environment further comprises: identifying, by the IRP engine, naming conventions and tagging within the hierarchy-level context of each hierarchy level patterns for the plurality of resources; suggesting, by the IRP engine, design patterns based on resource characteristics derived from the hierarchy-level context; validating, by the IRP engine, the design patterns across the plurality of hierarchy levels; and incorporating, by the IRP engine, the design patterns into the resource profiles of the plurality of resources.

Example 15 is a computer readable storage media comprising processor-executable instructions configured to cause a processor to: identify, by an in-situ resource profiler (IRP) engine, a networked environment for a security analysis, wherein the networked environment comprises a plurality of resources; determine, by the IRP engine, a plurality of hierarchy levels for the plurality of resources within the networked environment, wherein the plurality of hierarchy levels define an organizational architecture of the plurality of resources within the networked environment; determine, by the IRP engine, hierarchy-level context of each hierarchy level of the plurality of hierarchy levels; determine, by the IRP engine, a plurality of resource profiles for the plurality of resources at each hierarchy level; validate, by the IRP engine, the plurality of resource profiles across the plurality of hierarchy levels; and generate, by the IRP engine, a summary of the plurality of resource profiles for each hierarchy level at the plurality of hierarchy levels.

Example 16 is the computer readable storage media of any previous or subsequent example, wherein the processor-executable instructions cause the processor to further execute processor-executable instructions stored in the computer readable storage media to: detect, by the IRP engine, one or more potential security exposures within the networked environment based on the plurality of resource profiles; and generate, by the IRP engine, a recommendation for mitigating the one or more potential security exposures.

Example 17 is the computer readable storage media of any previous or subsequent example, wherein the processor-executable instructions to validate the plurality of resource profiles across the plurality of hierarchy levels cause the processor to further execute processor-executable instructions stored in the computer readable storage media to: determine, by the IRP engine, a first subset of resource profiles for a subset of resources at a first hierarchy level; determine, by the IRP engine, a second subset of resource profiles for the subset of resources at a second hierarchy level; compare, by the IRP engine, the first subset of resource profiles to the second subset of resource profiles to determine consistency of resource profiles for the subset of resources across the first hierarchy level and the second hierarchy level; and validate, by the IRP engine, that the first subset of resource profiles matches the second subset of resource profiles for the subset of resources based on the comparison.

Example 18 is the computer readable storage media of any previous or subsequent example, wherein the processor-executable instructions to validate the plurality of resource profiles across the plurality of hierarchy levels cause the processor to further execute processor-executable instructions stored in the computer readable storage media to: determine, by the IRP engine, a first subset of resource profiles for a subset of resources at a first hierarchy level; determine, by the IRP engine, a second subset of resource profiles for the subset of resources at a second hierarchy level; detect, by the IRP engine, a mismatch between the first subset of resource profiles and the second subset of resource profiles corresponding to the subset of resource; process, via a machine learning model of the IRP engine, the subset of resource profiles corresponding to the subset of resources across the plurality of hierarchy levels; and generate, via the machine learning model of the IRP engine, revised resource profiles for the subset of resources across the plurality of hierarchy levels, wherein the revised profiles for the subset of resources match across the plurality of hierarchy levels.

Example 19 is the computer readable storage media of any previous or subsequent example, wherein the processor-executable instructions to determine, by the IRP engine, the plurality of resource profiles for the plurality of resources at each hierarchy level cause the processor to further execute processor-executable instructions stored in the computer readable storage media to: analyze, by the IRP engine, historical usage data associated with the plurality of resources; and determine, by the IRP engine, the plurality of resource profiles for the plurality of resources based on the historical usage data.

Example 20 is the computer readable storage media of any previous or subsequent example, wherein the processor-executable instructions to generate, by the IRP engine, the summary of the plurality of resource profiles for each hierarchy level at the plurality of hierarchy levels cause the processor to further execute processor-executable instructions stored in the computer readable storage media to: analyze, by the IRP engine, a distribution of resource roles and design patterns for the plurality of resources across the plurality of hierarchy levels based on the plurality of resource profiles; identifying, by the IRP engine, common patterns in the plurality of resource profiles within and across the hierarchy levels based on the distribution; determining, by the IRP engine, a plurality of relationships between the resource roles and design patterns of the plurality of resources based on the plurality of resource profiles; and generating, by the IRP engine, the summary of the plurality of resource profiles, wherein the summary comprises the common patterns and plurality of relationships identified for the plurality of resources within the networked environment.

What is claimed is:

1. A computing apparatus comprising:
a computer-readable storage media comprising processor-executable instructions stored thereon; and
a processor coupled to the computer-readable storage media and configured to execute the processor-executable instructions that, when executed by the processor, direct the computing apparatus to at least:
access a contextual security representation of a networked environment, wherein the contextual security representation comprises a plurality of resources;
identify a plurality of hierarchy levels associated with the plurality of resources within the contextual security representation;
determine a plurality of hierarchy-level context for the plurality of hierarchy levels, wherein individual hierarchy-level contexts within the plurality of hierarchy-level context correspond to respective hierarchy levels within the plurality of hierarchy levels;
generate a plurality of resource profiles for the plurality of resources based on the hierarchy-level context, wherein a resource profile of the plurality of resource profiles corresponds to a respective resource of the plurality of resources; and
publish the plurality of resource profiles for the plurality of resources within the contextual security representation.

2. The computing apparatus of claim 1, wherein the processor-executable instructions, when executed by the processor, further direct the computing apparatus to:
generate a plurality of hierarchy-level summaries based on the plurality of resource profiles; and
validate, using a machine learning model, the plurality of hierarchy-level summaries across the plurality of hierarchy levels for consistency.

3. The computing apparatus of claim 1, wherein the processor-executable instructions, when executed by the processor, further direct the computing apparatus to:
perform a validation process on the plurality of resource profiles across the plurality of hierarchy levels;
identify one or more mismatches between a subset of resource profiles at different hierarchy levels based on the validation process; and
responsive to identifying the one or more mismatches, update the subset of resource profiles using additional contextual information from the contextual security representation.

4. The computing apparatus of claim 1, wherein the processor is further configured to execute the processor-executable instructions to:
identify a first security exposure for a first resource of the plurality of resources based on the plurality of resource profiles; and
generate a recommendation for mitigating the first security exposure, wherein the recommendation incorporates the first resource’s position within the plurality of hierarchy levels of the networked environment as represented in the contextual security representation.

5. The computing apparatus of claim 1, wherein:
the processor-executable instructions to determine the plurality of hierarchy-level context for the plurality of hierarchy levels, when executed by the processor, further direct the computing apparatus to:
query the contextual security representation to extract hierarchy-specific information for each hierarchy level of the plurality of hierarchy levels;
the processor-executable instructions to generate the plurality of resource profiles for the plurality of resources based on the hierarchy-level context, when executed by the processor, further direct the computing apparatus to:
determine, based on the hierarchy-specific information for the plurality of hierarchy levels, a network topology of the networked environment; and
determine, based on the network topology and the hierarchy-specific information, the plurality of resource profiles of the plurality of resources.

6. The computing apparatus of claim 1, wherein the processor-executable instructions to generate the plurality of resource profiles of the plurality of resources based on the plurality of hierarchy-level context, when executed by the processor, further direct the computing apparatus to:
process, via a machine learning model, each hierarchy-level context of the plurality of hierarchy-level contexts individually to generate a plurality of initial resource profiles corresponding to a subset of resources associated with a respective hierarchy level;
validate the initial resource profiles across the plurality of hierarchy levels; and
in response to detecting mismatches between hierarchy levels, analyze, via the machine learning model, the plurality hierarchy-level contexts together in view of previous findings to generate a refined resource profile.

7. A method comprising:
identifying, by an in-situ resource profiler (IRP) engine, a plurality of hierarchy levels within a networked environment, wherein the plurality of hierarchy levels define an organizational architecture of a plurality of resources within the networked environment;
determining, by the IRP engine, hierarchy-level context of each hierarchy level of the plurality of hierarchy levels;
generating, by the IRP engine, a plurality of resource profiles for the plurality of resources within the networked environment, wherein a resource profile of the plurality of resource profiles comprises a resource role and design pattern of a respective resource of the plurality of resources within the networked environment; and
detecting, by the IRP engine, one or more potential security exposures within the networked environment based on the plurality of resource profiles.

8. The method of claim 7, wherein:
determining, by the IRP engine, the hierarchy-level context of each hierarchy level of the plurality of hierarchy levels comprises:
extracting from a contextual security representation, by the IRP engine, hierarchy-specific information for each hierarchy level of the plurality of hierarchy levels; and
determining, by the IRP engine, network topology of the networked environment based on the hierarchy-specific information; and
generating, by the IRP engine, the plurality of resource profiles for the plurality of resources within the networked environment comprises:
determining, by the IRP, a resource role and design pattern for each resource of the plurality of resources based on the network topology and hierarchy-specific information, wherein a resource profile comprises the resource role and design pattern of a respective resource.

9. The method of claim 7, wherein detecting, by the IRP engine, the one or more potential security exposures within the networked environment based on the plurality of resource profiles comprises:
comparing, by the IRP engine, the plurality of resource profiles to one or more predefined security policies;
identifying, by the IRP engine, a subset of resource profiles that deviate from the predefined security policies;
performing, by the IRP engine, a risk analysis on the subset of resource profiles in view of the hierarchy-level context of the plurality of hierarchy levels; and
flagging, by the IRP engine, the one or more potential security exposures for the subset of resource profiles based on the risk analysis.

10. The method of claim 7, wherein determining, by the IRP engine, the hierarchy-level context of each hierarchy level of the plurality of hierarchy levels comprises:
extracting from a contextual security representation, by the IRP engine, hierarchy-specific information for each hierarchy level of the plurality of hierarchy levels; and
determining, by the IRP engine, identity topology of the plurality of resources within the networked environment based on the hierarchy-specific information.

11. The method of claim 7, wherein generating, by the IRP engine, the plurality of resource profiles for the plurality of resources within the networked environment comprises:
processing, via a machine learning model, the hierarchy-level context for the plurality of hierarchy levels, wherein the machine learning model outputs a resource role and design pattern for each resource in the plurality of resources; and
generating, by the IRP engine, the plurality of resource profiles for the plurality of resources based on the resource role and design pattern output by the machine learning model.

12. The method of claim 7, wherein the method further comprises:
analyzing, by the IRP engine, a distribution of resource roles and design patterns for the plurality of resources across the plurality of hierarchy levels based on the plurality of resource profiles;
identifying, by the IRP engine, common patterns in the plurality of resource profiles within and across the hierarchy levels based on the distribution;
determining, by the IRP engine, a plurality of relationships between the resource roles and design patterns of the plurality of resources based on the plurality of resource profiles; and
generating, by the IRP engine, a summary of the plurality of resource profiles, wherein the summary comprises the common patterns and plurality of relationships identified for the plurality of resources within the networked environment.

13. The method of claim 12, wherein the method further comprises:
generating, by the IRP engine, one or more recommendations for resource allocation and resource configuration for the plurality of resources based on the summary.

14. The method of claim 7, wherein generating, by the IRP engine, the plurality of resource profiles for the plurality of resources within the networked environment further comprises:
identifying, by the IRP engine, naming conventions and tagging within the hierarchy-level context of each hierarchy level patterns for the plurality of resources;
suggesting, by the IRP engine, design patterns based on resource characteristics derived from the hierarchy-level context;
validating, by the IRP engine, the design patterns across the plurality of hierarchy levels; and
incorporating, by the IRP engine, the design patterns into the resource profiles of the plurality of resources.

15. A computer readable storage media comprising processor-executable instructions configured to cause a processor to:
identify, by an in-situ resource profiler (IRP) engine, a networked environment for a security analysis, wherein the networked environment comprises a plurality of resources;
determine, by the IRP engine, a plurality of hierarchy levels for the plurality of resources within the networked environment, wherein the plurality of hierarchy levels define an organizational architecture of the plurality of resources within the networked environment;
determine, by the IRP engine, hierarchy-level context of each hierarchy level of the plurality of hierarchy levels;
determine, by the IRP engine, a plurality of resource profiles for the plurality of resources at each hierarchy level;
validate, by the IRP engine, the plurality of resource profiles across the plurality of hierarchy levels; and
generate, by the IRP engine, a summary of the plurality of resource profiles for each hierarchy level at the plurality of hierarchy levels.

16. The computer readable storage media of claim 15, wherein the processor-executable instructions cause the processor to further execute processor-executable instructions stored in the computer readable storage media to:
detect, by the IRP engine, one or more potential security exposures within the networked environment based on the plurality of resource profiles; and
generate, by the IRP engine, a recommendation for mitigating the one or more potential security exposures.

17. The computer readable storage media of claim 15, wherein the processor-executable instructions to validate the plurality of resource profiles across the plurality of hierarchy levels cause the processor to further execute processor-executable instructions stored in the computer readable storage media to:
determine, by the IRP engine, a first subset of resource profiles for a subset of resources at a first hierarchy level;
determine, by the IRP engine, a second subset of resource profiles for the subset of resources at a second hierarchy level;
compare, by the IRP engine, the first subset of resource profiles to the second subset of resource profiles to determine consistency of resource profiles for the subset of resources across the first hierarchy level and the second hierarchy level; and
validate, by the IRP engine, that the first subset of resource profiles matches the second subset of resource profiles for the subset of resources based on the comparison.

18. The computer readable storage media of claim 15, wherein the processor-executable instructions to validate the plurality of resource profiles across the plurality of hierarchy levels cause the processor to further execute processor-executable instructions stored in the computer readable storage media to:
determine, by the IRP engine, a first subset of resource profiles for a subset of resources at a first hierarchy level;
determine, by the IRP engine, a second subset of resource profiles for the subset of resources at a second hierarchy level;
detect, by the IRP engine, a mismatch between the first subset of resource profiles and the second subset of resource profiles corresponding to the subset of resource;
process, via a machine learning model of the IRP engine, the subset of resource profiles corresponding to the subset of resources across the plurality of hierarchy levels; and
generate, via the machine learning model of the IRP engine, revised resource profiles for the subset of resources across the plurality of hierarchy levels, wherein the revised resource profiles for the subset of resources match across the plurality of hierarchy levels.

19. The computer readable storage media of claim 15, wherein the processor-executable instructions to determine, by the IRP engine, the plurality of resource profiles for the plurality of resources at each hierarchy level cause the processor to further execute processor-executable instructions stored in the computer readable storage media to:
analyze, by the IRP engine, historical usage data associated with the plurality of resources; and
determine, by the IRP engine, the plurality of resource profiles for the plurality of resources based on the historical usage data.

20. The computer readable storage media of claim 15, wherein the processor-executable instructions to generate, by the IRP engine, the summary of the plurality of resource profiles for each hierarchy level at the plurality of hierarchy levels cause the processor to further execute processor-executable instructions stored in the computer readable storage media to:
analyze, by the IRP engine, a distribution of resource roles and design patterns for the plurality of resources across the plurality of hierarchy levels based on the plurality of resource profiles;
identifying, by the IRP engine, common patterns in the plurality of resource profiles within and across the hierarchy levels based on the distribution;
determining, by the IRP engine, a plurality of relationships between the resource roles and design patterns of the plurality of resources based on the plurality of resource profiles; and
generating, by the IRP engine, the summary of the plurality of resource profiles, wherein the summary comprises the common patterns and plurality of relationships identified for the plurality of resources within the networked environment.
